(19) United States
(12) Patent Application Publication
(10) Pub. No.: US 2015/0219127 A1
(43) Pub. Date: Aug. 6, 2015

(54) HYDRAULIC SYSTEM FOR CONSTRUCTION MACHINERY

(71) Applicants: Hung-Ju Shin, Busan (KR); Byeong-Soo Kim, Changwon-si (KR)

(72) Inventors: Hung-Ju Shin, Busan (KR); Byeong-Soo Kim, Changwon-si (KR)

(73) Assignee: VOLVO CONSTRUCTION EQUIPMENT AB, Eskilstuna (SE)

(21) Appl. No.: 14/419,370

(22) PCT Filed: Aug. 27, 2012
(86) PCT No.: PCT/KR2012/006844

§ 371 Date: Feb. 3, 2015

(51) Int. Cl. F15B 21/08; F15B 13/04; F15B 13/02; F15B 13/06; E02F 9/22; E02F 9/20

(52) U.S. Cl. CPC F15B 21/08; E02F 9/2292; E02F 9/2004; E02F 9/2267; E02F 9/2296; F15B 13/022; F15B 13/06; F15B 13/0402

(57) ABSTRACT

A hydraulic system for a construction machine is provided, which enables a user to set or release a preferential function when an excavation work or leveling work using an excavator is performed. The hydraulic system for a construction machine includes first and second hydraulic pumps connected to an engine; first and second hydraulic actuators connected to the first and second hydraulic pumps; main control valves (MCV) installed in flow paths between the first and second hydraulic pumps and the first and second hydraulic actuators, respectively, and having spools shifted to control a start, a stop, and a direction change of the first and second hydraulic actuators; first and second operation levers outputting operation signals in proportion to a user's operation amount; a control device limiting a flow rate that is applied to the spool of any one of the first and second hydraulic actuators that share the first and second hydraulic pumps according to a user's operation of the first or second operation lever for a preferential function; and a control unit controlling driving of the control device so as to shift to or release the preferential function according to a user's determination.

### TECHNICAL FIELD

The present disclosure relates to a hydraulic system for a construction machine, and more particularly, to a hydraulic system for a construction machine, which enables an operator to set or release a preferential function when an excavation work or leveling work using an excavator is performed.

### BACKGROUND OF THE INVENTION

Generally, in a construction machine, such as an excavator, to which an open center type hydraulic system is applied, a plurality of variable displacement main hydraulic pumps are used to make hydraulic fluid on the side of a first hydraulic pump join hydraulic fluid that is supplied to a hydraulic actuator on the side of a second hydraulic pump according to a work type to secure workability. In this case, the hydraulic fluid may not be smoothly distributed and supplied according to an operator's operation amount of an operation lever depending on the degree of load generated in the hydraulic actuators. In this case, in order to secure a predetermined amount of hydraulic fluid in the corresponding hydraulic actuator, a preferential function is performed to reduce an aperture ratio of a spool on the side of the hydraulic actuator, which has a relatively low load pressure or to limit flow paths.

A hydraulic system for a construction machine having a preferential function in the related art, as illustrated in FIG. 1, includes first and second variable displacement hydraulic pumps (hereinafter referred to as “first and second hydraulic pumps”) 1 and 2 connected to an engine (not illustrated); a first hydraulic actuator (e.g., boom cylinder) connected to the first hydraulic pump 1; a second hydraulic actuator (e.g., arm cylinder) connected to the second hydraulic pump 2; spools 3 and 3a installed in a flow path between the first hydraulic pump 1 and the first hydraulic actuator and shifted to control a start, a stop, and a direction change of the first hydraulic actuator; spools 4 and 4a installed in a flow path between the second hydraulic pump 2 and the second hydraulic actuator and shifted to control a start, a stop, and a direction change of the second hydraulic actuator; first and second operation levers 5 and 6 outputting operation signals in proportion to an operator's operation amount; a first preferential function valve 7 installed in a signal flow path between the first operation lever 5 and the spool 4a to shift the flow path in proportion to a level of signal pressure applied when the second operation lever 6 is operated to intercept a control signal applied to the spool 4a; and a second preferential function valve 8 installed in a signal flow path between the second operation lever 6 and the spool 3a to shift the flow path in proportion to a level of signal pressure applied when the first operation lever 5 is operated to intercept a control signal applied to the spool 3a.

According to the hydraulic system having a preferential function as described above, when the first operation lever 5 is operated, signal pressure is applied to the spools 4 and 4a to shift the spools 4 and 4a, and signal pressure is simultaneously applied to the second preferential function valve 8 to shift the spool in a downward direction in the drawing. Through this, hydraulic fluid from the first hydraulic pump 1 drives the corresponding hydraulic actuator through the shifted spool 4, and hydraulic fluid from the second hydraulic pump 2 drives the corresponding hydraulic actuator through the shifted spool 4a.

In this case, when the second operation lever 6 is operated, the signal pressure that is applied to the spool 3a is limited, and the hydraulic fluid from the first hydraulic pump 1 is preferentially supplied to the first hydraulic actuator mainly through the spool 4 while the amount of hydraulic fluid that flows to the second hydraulic actuator is limited.

On the other hand, when the second operation lever 6 is operated, the signal pressure is applied to the spools 3 and 3a to shift the spools 3 and 3a, and the signal pressure is simultaneously applied to the first preferential function valve 7 to shift the spool in an upward direction in the drawing. Through this, the hydraulic fluid from the first hydraulic pump 1 drives the corresponding hydraulic actuator through the shifted spool 3a, and the hydraulic fluid from the second hydraulic pump 2 drives the corresponding hydraulic actuator through the shifted spool 3.

In this case, when the first operation lever 5 is operated, the signal pressure that is applied to the spool 4a is limited, and the hydraulic fluid from the second hydraulic pump 2 is preferentially supplied to the second hydraulic actuator mainly through the spool 3 while the amount of hydraulic fluid that flows to the first hydraulic actuator is limited.

As described above, when an excavation work or leveling work is performed using the hydraulic system having the preferential function, arm-in driving or boom-up driving is preferentially performed to perform the desired work.

On the other hand, in the case where the first and second operation levers 5 and 6 are simultaneously operated to perform the leveling work using an excavator, the signal pressure according to the operation of the first operation lever 5 is applied to the second preferential function valve 8 to shift the spool in a downward direction in the drawing, and thus the signal pressure that is applied to the spool 3a is intercepted. At the same time, the signal pressure according to the operation of the second operation lever 6 is applied to the first preferential function valve 7 to shift the spool in an upward direction in the drawing, and thus the signal pressure that is applied to the spool 4a is intercepted.

Through this, the hydraulic fluid from the first hydraulic pump 1 is supplied to the first hydraulic actuator mainly through the shifted spool 4, and the hydraulic fluid from the second hydraulic pump 2 is supplied to the second hydraulic actuator mainly through the shifted spool 3.

As described above, in the case of performing the leveling work through simultaneous operation of the boom and the arm, the increasing rate of the hydraulic fluid that is supplied to the corresponding hydraulic actuator side abruptly becomes different from the increasing rate of the operator's operation amount of the operation lever due to the preferential function of the boom or the arm, and thus the operator is faced with difficulty in operating the above-described working devices.

### SUMMARY OF THE INVENTION

Therefore, one embodiment of the present disclosure is related to a hydraulic system for a construction machine, which enables an operator to set or release a preferential function according to a work type using an excavator and thus can improve operability and workability.

### TECHNICAL SOLUTION

In accordance with an aspect of the present disclosure, there is provided a hydraulic system for a construction machine, which includes first and second variable displacement hydraulic pumps connected to an engine; first and second hydraulic actuators connected to the first and second hydraulic pumps; main control valves installed in flow paths between the first and second hydraulic pumps and the first and second hydraulic actuators, respectively, and having spools shifted to control a start, a stop, and a direction change of the first and second hydraulic actuators; first and second operation levers outputting operation signals in proportion to a user's operation amount; a control device limiting a flow rate that is applied to the spool of any one of the first and second hydraulic actuators that share the first and second hydraulic pumps according to a user's operation of the first or second operation lever for a preferential function; and a control unit controlling driving of the control device so as to shift to or release the preferential function according to a user's determination.

In a preferred embodiment, an on/off switch type input means may be provided as a means for shifting to or releasing the preferential function according to the user's determination.

A cluster that is installed in a cab may be provided as a means for shifting to or releasing the preferential function according to the user's determination.

The control device may include a first preferential function valve installed in a signal path between the first operation lever and any one of the spools on the second hydraulic pump side; a second preferential function valve installed in a signal path between the second operation lever and any one of the spools on the first hydraulic pump side; a first preferential function setting valve installed in a signal path between the second operation lever and the first preferential function valve and shifted to intercept an application of signal pressure according to an operation of the second operation lever to the first preferential function valve in response to a control signal from the control unit to release the preferential function; and a second preferential function setting valve installed in a signal path between the first operation lever and the second preferential function valve and shifted to intercept an application of signal pressure according to an operation of the first operation lever to the second preferential function valve in response to the control signal from the control unit to release the preferential function.

The control device may include a first pressure sensor detecting the signal pressure according to the operation of the first operation lever and transmitting a detection signal to the control unit; a second pressure sensor detecting the signal pressure according to the operation of the second operation lever and transmitting a detection signal to the control unit; a first electro proportional pressure reducing valve connected to any one of the spools on the second hydraulic pump side so as to reduce a secondary signal pressure that is applied to any one of the spools on the second hydraulic pump side in reverse proportion to the operation amount of the second operation lever detected when shifted to the preferential function and to output the signal pressure according to the operation amount of the first operation lever when released to the preferential function; and a second electro proportional pressure reducing valve connected to any one of the spools on the first hydraulic pump side so as to reduce a secondary signal pressure that is applied to any one of the spools on the first hydraulic pump side in reverse proportion to the operation amount of the first operation lever detected when shifted to the preferential function and to output the signal pressure according to the operation amount of the second operation lever when released to the preferential function.

Solenoid valves may be used as the first and second preferential function setting valves.

The on/off switch of the input means may be mounted on the first operation lever or the second operation lever.

### Advantageous Effect

The hydraulic system for a construction machine as configured above according to the aspect of the present disclosure has the following advantages.

Since the operator can always set or release the preferential function according to the work type, such as the excavating work or leveling work, the operation can be facilitated and thus the work efficiency can be improved.

### BRIEF DESCRIPTION OF THE DRAWINGS

FIG. 1 is a schematic view of a hydraulic system for a construction machine in the related art;

FIG. 2 is a schematic view of a hydraulic system for a construction machine according to an embodiment of the present disclosure; and

FIG. 3 is a schematic view of a hydraulic system for a construction machine according to another embodiment of the present disclosure.

### DESCRIPTION OF REFERENCE NUMERALS IN THE DRAWING

1: first variable displacement hydraulic pump
2: second variable displacement hydraulic pump
3, 3a, 4, 4a: spool
5: first operation lever
6: second operation lever
7: first preferential function valve
8: second preferential function valve
9: first preferential function setting valve
10: second preferential function setting valve
11: control unit
12: first electro proportional pressure reducing valve
13: second electro proportional pressure reducing valve
14: second pressure sensor
15: first pressure sensor

### DETAILED DESCRIPTION OF THE INVENTION

Hereinafter, preferred embodiments of the present disclosure will be described in detail with reference to the accompanying drawings. The matters defined in the description, such as the detailed construction and elements, are nothing but specific details provided to assist those of ordinary skill in the art in a comprehensive understanding of the disclosure, and the present disclosure is not limited to the embodiments disclosed hereinafter.

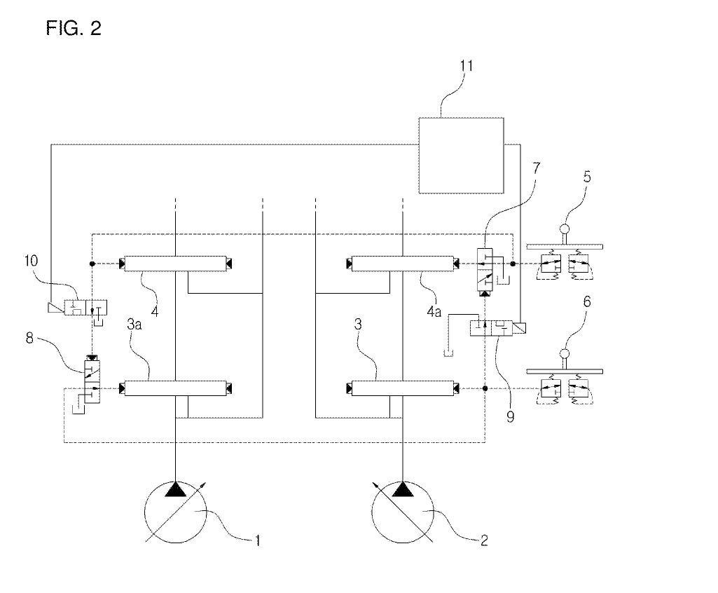

A hydraulic system for a construction machine according to an embodiment of the present disclosure, as illustrated in FIG. 2, includes first and second variable displacement hydraulic pumps (hereinafter referred to as “first and second hydraulic pumps”) 1 and 2 connected to an engine (not illustrated); first and second hydraulic actuators (e.g., boom cylinder or arm cylinder) connected to the first and second hydraulic pumps 1 and 2; main control valves (MCV) installed in flow paths between the first and second hydraulic pumps 1 and 2 and the first and second hydraulic actuators, respectively, and having spools 3, 3a, 4, and 4a shifted to control a start, a stop, and a direction change of the first and second hydraulic actuators; first and second operation levers 5 and 6 outputting operation signals in proportion to a user's operation amount; a control device 11 limiting a flow rate that is applied to the spool of any one of the first and second hydraulic actuators that share the first and second hydraulic pumps 1 and 2 according to a user's operation of the first or second operation lever 6 for a preferential function; and a control unit 11 controlling driving of the control device 11 so as to shift to or release the preferential function according to a user's determination.

Although not illustrated in the drawing, an on/off switch type input means may be provided as a means for shifting to or releasing the preferential function according to the user's determination. Through this, the operator can conveniently perform shifting to or releasing the preferential function according to the work type through pressing of the on/off switch (e.g., once pressing of the on/off switch corresponds to shifting to the preferential function, and twice pressing of the on/off switch corresponds to releasing the preferential function).

Although not illustrated in the drawing, a cluster that is installed in a cab may be provided as a means for shifting to or releasing the preferential function according to the user's determination. Through this, the operator can conveniently select shifting to or releasing the preferential function through a menu provided on the screen during working.

The control device 11 may include a first preferential function valve 7 installed in a signal path between the first operation lever 5 and any one 4a of the spools on the side of the second hydraulic pump 2; a second preferential function valve 8 installed in a signal path between the second operation lever 6 and any one 4a of the spools on the side of the first hydraulic pump 1; a first preferential function setting valve 9 installed in a signal path between the second operation lever 6 and the first preferential function valve 7 and shifted to intercept an application of signal pressure according to an operation of the second operation lever 6 to the first preferential function valve 7 in response to a control signal from the control unit 11 to release the preferential function; and a second preferential function setting valve 10 installed in a signal path between the first operation lever 5 and the second preferential function valve 8 and shifted to intercept an application of signal pressure according to an operation of the first operation lever 5 to the second preferential function valve 8 in response to the control signal from the control unit 11 to release the preferential function.

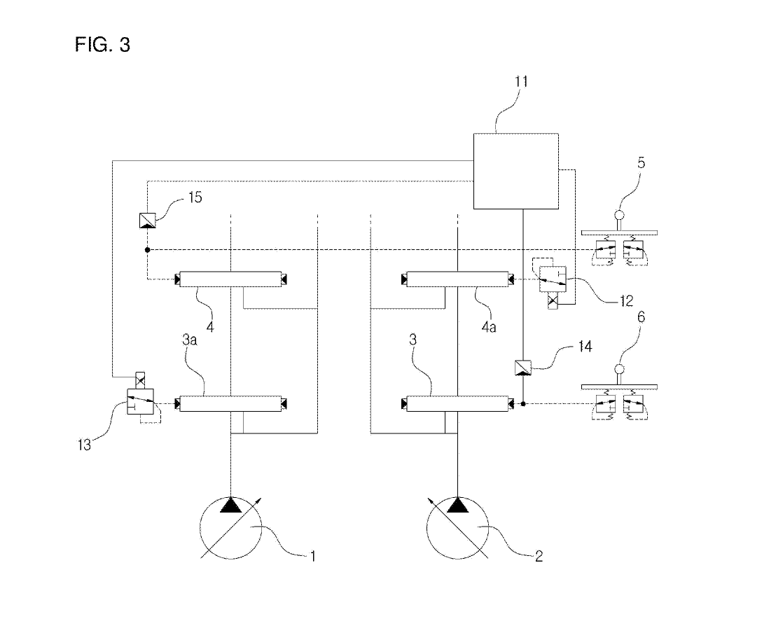

As illustrated in FIG. 3, the control device may include a first pressure sensor 15 detecting the signal pressure according to the operation of the first operation lever 5 and transmitting a detection signal to the control unit 11; a second pressure sensor 14 detecting the signal pressure according to the operation of the second operation lever 6 and transmitting a detection signal to the control unit 11; a first electro proportional pressure reducing valve 12 connected to any one 4a of the spools on the side of the second hydraulic pump 2 so as to reduce a secondary signal pressure that is applied to any one 4a of the spools on the side of the second hydraulic pump 2 in reverse proportion to the operation amount of the second operation lever 6 detected when shifted to the preferential function and to output the signal pressure according to the operation amount of the first operation lever 5 when released to the preferential function; and a second electro proportional pressure reducing valve 13 connected to any one 3a of the spools on the side of the first hydraulic pump 1 so as to reduce a secondary signal pressure that is applied to any one 3a of the spools on the side of the first hydraulic pump 1 in reverse proportion to the operation amount of the first operation lever 5 detected when shifted to the preferential function and to output the signal pressure according to the operation amount of the second operation lever 6 when released to the preferential function.

Solenoid valves may be used as the first and second preferential function setting valves 7 and 8.

The on/off switch of the input means may be mounted on the first operation lever 5 or the second operation lever 6. Through this, while the first and second operation levers 5 and 6 are operated, the operator can operate the on/off switches mounted on the first and second operation levers 5 and 6 without separating the hands from the first and second operation levers 5 and 6, and thus can easily perform shifting to or releasing the preferential function.

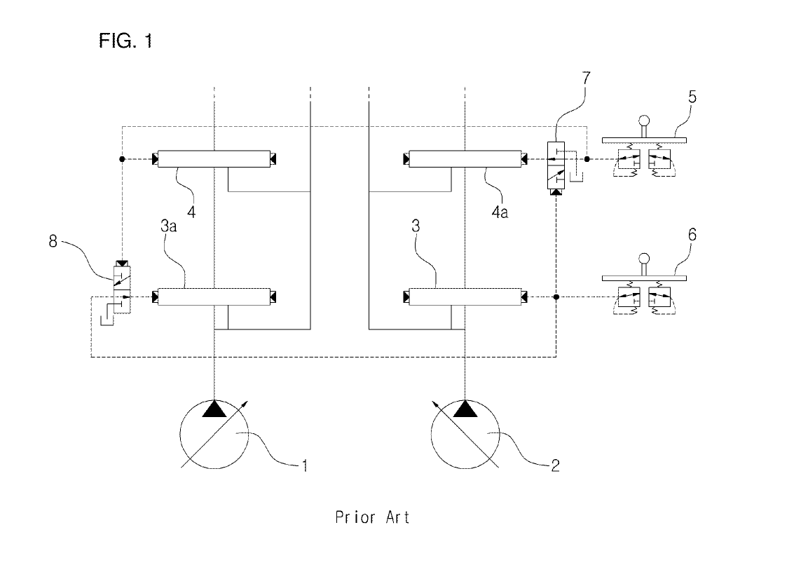

In this case, since the configurations of the hydraulic system, except for the first and second preferential function valves 7 and 8, the first and second preferential function setting valves 9 and 10, and the control unit 11, which constitute the preferential function control device illustrated in FIG. 2, and the first and second electro proportional pressure reducing valves 12 and 13, the first and second pressure sensors 14 and 15, and the control unit 11, which constitute the preferential function control device illustrated in FIG. 3, are the same as the configurations of the hydraulic system illustrated in FIG. 1, the detailed explanation of the duplicate configurations will be omitted, and the same reference numerals are given to the duplicate configurations.

Hereinafter, the operation of the hydraulic system for a construction machine according to an embodiment of the present disclosure will be described.

As illustrated in FIG. 2, when the second operation lever 6 is operated by an operator, signal pressure is applied to the spools 3 and 3a on the side of the first and second hydraulic pumps 1 and 2, and is simultaneously applied to the first preferential function valve 7 to shift the spools in an upward direction in the drawing. Through this, the signal path between the first operation lever 5 and the spool 4a on the side of the second hydraulic pump 2 is intercepted, and thus the signal pressure according to the operation of the first operation lever 5 is not transferred to the spool 4a.

In this case, if the on/off switch that is mounted on the first and second operation levers 5 and 6 is operated in order for the operator to release the preferential function so that the leveling work can be performed using the excavator, a control signal from the control unit 11 is applied to the first preferential function setting valve 9. Through this, the spool is shifted in a leftward direction in the drawing, and thus the signal pressure according to the operation of the second operation lever 6 is not transferred to the first preferential function valve 7 by the shifted first preferential function setting valve 9.

Accordingly, the signal pressure according to the operation of the first operation lever 5 is not intercepted by the operation of the second operation lever 6, but can be transferred to the spool 4a on the side of the second hydraulic pump 2 through the first preferential function valve 7.

On the other hand, the configuration for transferring the signal pressure according to the operation of the first operation lever 5 to the spool 3a on the side of the first hydraulic pump 1 through the second preferential function valve 8 through applying of the control signal from the control unit 11 to the second preferential function setting valve 10 during releasing of the preferential function is the same as the configuration for transferring the signal pressure according to the operation of the second operation lever 6 to the spool 4a on the side of the second hydraulic pump 2 through the first preferential function valve 7 and the first preferential function setting valve 9, and thus the detailed explanation thereof will be omitted.

As shown in FIG. 3, in the case of operating the second operation lever 6, the signal pressure is transferred to the spool 3 on the side of the second hydraulic pump 2, and at the same time, the signal pressure according to the operation amount of the second operation lever 6 is detected by the second pressure sensor 14 and is transmitted to the control unit 11. Through this, in the case of shifting to the preferential function by the operator, a control signal is applied from the control unit 11 to the first electro proportional pressure reducing valve 12 so that a secondary signal pressure that is in reverse proportion to the detected operation amount of the second operation lever 6 is output.

Accordingly, the decreased secondary signal pressure that is output from the first electro proportional pressure reducing valve 12 can be applied to the spool 4a on the side of the second hydraulic pump 2.

On the other hand, in the case where the operator releases the preferential function so that the leveling work using the excavator can be performed, the signal pressure that is applied to the spool 4 on the side of the first hydraulic pump 1 according to the operation of the first operation lever 5 is detected by the first pressure sensor 15, and a detection signal is transmitted to the control unit 11. Through this, the control unit 11 outputs a control signal to the first electro proportional pressure reducing valve 12 so that the secondary signal pressure that is equal to the signal pressure that is applied to the spool 4 can be applied to the spool 4a.

On the other hand, the configuration for reducing the secondary signal pressure that is applied to the spool 3a on the side of the first hydraulic pump 1 in reverse proportion to the operation amount of the first operation lever 5 that is detected by the first pressure sensor 15 during shifting to the preferential function and transferring the secondary signal pressure that is equal to the signal pressure that is applied to the spool 3 during releasing of the preferential function is the same as the configuration for controlling the secondary signal pressure that is transferred to the spool 4a on the side of the second hydraulic pump 2 through the second pressure sensor 14 and the first electro proportional pressure reducing valve 12 as described above, and thus the detailed explanation thereof will be omitted.

On the other hand, in comparison to the control device that is composed of the first and second preferential function valves 7 and 8 and the first and second preferential function setting valves 9 and 10 as illustrated in FIG. 2 to set and release the preferential function, the configuration of the control device that is composed of the first and second pressure sensors 14 and 15 and the first and second electro proportional pressure reducing valves 12 and 13 is relatively simpler, and thus the hydraulic circuit can be simplified. Further, since the electro proportional pressure reducing valves are used, higher flexibility can be given with respect to the change of the specifications.

Although the disclosure has been described with reference to the preferred embodiments in the attached figures, it is noted that equivalents may be employed and substitutions made herein without departing from the scope of the disclosure as recited in the claims.

### INDUSTRIAL APPLICABILITY

According to the present disclosure having the above-described configuration, since the operator can always set or release the preferential function according to the work type, such as the excavating work or leveling work, the operation can be facilitated.

1. A hydraulic system for a construction machine, comprising:
first and second variable displacement hydraulic pumps connected to an engine;
first and second hydraulic actuators connected to the first and second hydraulic pumps;
main control valves installed in flow paths between the first and second hydraulic pumps and the first and second hydraulic actuators, respectively, and having spools shifted to control a start, a stop, and a direction change of the first and second hydraulic actuators;
first and second operation levers outputting operation signals in proportion to a user's operation amount;
a control device limiting a flow rate that is applied to the spool of any one of the first and second hydraulic actuators that share the first and second hydraulic pumps according to a user's operation of the first or second operation lever for a preferential function; and
a control unit controlling driving of the control device so as to shift to or release the preferential function according to a user's determination.

2. The hydraulic system as claimed in claim 1, wherein an on/off switch type input means is provided as a means for shifting to or releasing the preferential function according to the user's determination.

3. The hydraulic system as claimed in claim 1, wherein a cluster that is installed in a cab is provided as a means for shifting to or releasing the preferential function according to the user's determination.

4. The hydraulic system as claimed in claim 1, wherein the control device comprises:
a first preferential function valve installed in a signal path between the first operation lever and any one of the spools on the second hydraulic pump side;
a second preferential function valve installed in a signal path between the second operation lever and any one of the spools on the first hydraulic pump side;
a first preferential function setting valve installed in a signal path between the second operation lever and the first preferential function valve and shifted to intercept an application of signal pressure according to an operation of the second operation lever to the first preferential function valve in response to a control signal from the control unit to release the preferential function; and
a second preferential function setting valve installed in a signal path between the first operation lever and the second preferential function valve and shifted to intercept an application of signal pressure according to an operation of the first operation lever to the second preferential function valve in response to the control signal from the control unit to release the preferential function.

5. The hydraulic system as claimed in claim 1, wherein the control device comprises:
a first pressure sensor detecting the signal pressure according to the operation of the first operation lever and transmitting a detection signal to the control unit;
a second pressure sensor detecting the signal pressure according to the operation of the second operation lever and transmitting a detection signal to the control unit;
a first electro proportional pressure reducing valve connected to any one of the spools on the second hydraulic pump side so as to reduce a secondary signal pressure that is applied to any one of the spools on the second hydraulic pump side in reverse proportion to the operation amount of the second operation lever detected when shifted to the preferential function and to output the signal pressure according to the operation amount of the first operation lever when released to the preferential function; and
a second electro proportional pressure reducing valve connected to any one of the spools on the first hydraulic pump side so as to reduce a secondary signal pressure that is applied to any one of the spools on the first hydraulic pump side in reverse proportion to the operation amount of the first operation lever detected when shifted to the preferential function and to output the signal pressure according to the operation amount of the second operation lever when released to the preferential function.

6. The hydraulic system as claimed in claim 4, wherein solenoid valves are used as the first and second preferential function setting values.

7. The hydraulic system as claimed in claim 2, wherein the on/off switch of the input means is mounted on the first operation lever or the second operation lever.
